(19) United States
(12) Patent Application Publication
(10) Pub. No.: US 2015/0240142 A1
(43) Pub. Date: Aug. 27, 2015

(54) Compositions and Methods for Completing Subterranean Wells

(71) Applicant: SCHLUMBERGER TECHNOLOGY CORPORATION, Sugar Land,, TX (US)

(72) Inventors: Slaheddine Kefi, Velizy-Villacoublay (FR); Nora Bennani, Paris (FR); Elena Pershikova Tomilina, Westhill (GB)

(21) Appl. No.: 14/437,498

(22) PCT Filed: Apr. 9, 2013
(86) PCT No.: PCT/EP2013/001041

§ 371 Date: Apr. 21, 2015

(30) Foreign Application Priority Data
Oct. 26, 2012 (EP) 12190217.5

(51) Int. Cl. C09K 8/06; C09K 8/52; E21B 33/14; C09K 8/40

(52) U.S. Cl. CPC C09K 8/06; C09K 8/40; C09K 8/52; E21B 33/14

(57) ABSTRACT

Well treatment compositions comprise water, a lipophilic anionic surfactant, a hydrophilic non-ionic surfactant, a second non-ionic surfactant and a water-miscible solvent. Optionally, a second solvent may be incorporated. When added to spacer fluids, chemical washes or both, the compositions promote the removal of non-aqueous drilling fluids from casing surfaces. Additionally, the treated casing surfaces are water wet, thereby promoting optimal bonding to cement.

### BACKGROUND

The statements in this section merely provide background information related to the present disclosure and may not constitute prior art.

This disclosure relates to compositions and methods for completing subterranean wells, in particular, fluid compositions and methods for completion operations during which the fluid compositions are pumped into a wellbore and make contact with subterranean rock formations.

In the course of completing oil and gas wells and the like, various types of fluids are circulated in the wellbore. These fluids include, but are not limited to, drilling fluids, spacer fluids, cement slurries and gravel-packing fluids. In addition, these fluids typically contain solid particles.

Cement slurries are usually incompatible with most drilling fluids. If the cement slurry and drilling fluid commingle, a highly viscous mass may form that can cause several problems. Cement slurry can channel through the viscous mass. Unacceptably high friction pressures can develop during the cement job. Plugging of the annulus can result in job failure. In all of these situations, zonal isolation may be compromised, and expensive remedial cementing may be required.

Consequently, intermediate fluids called preflushes are often pumped as buffers to prevent contact between cement slurries and drilling fluids. Preflushes can be chemical washes that contain no solids or spacer fluids that contain solids and can be mixed at various densities.

Spacers are preflushes with carefully designed densities and rheological properties. Spacers are more complicated chemically than washes. Viscosifiers are necessary to suspend the solids and control the rheological properties, and usually comprise water-soluble polymers, clays or both. Other chemical components include dispersants, fluid-loss control agents, weighting agents, antifoam agents and surfactants. A thorough discussion concerning the uses and compositions of preflushes may be found in the following publication. Daccord G, Guillot D and Nilsson F: “Mud Removal,” in Nelson E B and Guillot D (eds.): Well Cementing-2^{nd} Edition, Houston: Schlumberger (2006) 183-187. The entire content of the publication, Well Cementing-2^{nd} Edition, is hereby incorporated by reference into the current application.

For optimal fluid displacement, the density of a spacer fluid should usually be higher than that of the drilling fluid and lower than that of the cement slurry. Furthermore, the viscosity of the spacer fluid is usually designed to be higher than the drilling fluid and lower than the cement slurry. The spacer fluid must remain stable throughout the cementing process (i.e., no free-fluid development and no sedimentation of solids). In addition, it may be necessary to control the fluid-loss rate.

Another important function of preflushes is to leave the casing and formation surfaces water wet, thereby promoting optimal bonding with the cement. Achieving water-wet surfaces may be challenging, especially when the drilling fluid has been non-aqueous. Such non-aqueous fluids (NAF) may be oil-base muds or emulsion muds whose external phase is oil-base. For these circumstances, special dispersant and surfactant systems have been developed by the industry. Designing a dispersant/surfactant system for a particular well may be complicated because several parameters must be considered, including the base oil of the NAF, the presence of emulsifiers, the fluid density, bottomhole temperature, presence of brine salts and the chemical nature of the cement system.

### SUMMARY

In an aspect, embodiments relate to well treatment compositions, comprising water, a lipophilic anionic surfactant, a hydrophilic non-ionic surfactant, a second non-ionic surfactant and a water-miscible solvent.

In a further aspect, embodiments relate to methods for treating a subterranean well having at least one casing string, comprising preparing an aqueous spacer fluid, chemical wash or both and adding a well treatment composition to the fluid, wash or both. The composition comprises water, a lipophilic anionic surfactant, a hydrophilic non-ionic surfactant, a second non-ionic surfactant and a water-miscible solvent. Then the fluid, wash or both containing the composition are placed in the well such that the fluid, wash or both flow past the external surface of the casing string.

In yet a further aspect, embodiments relate to methods for cementing a subterranean well having at least one casing string, comprising preparing an aqueous spacer fluid, chemical wash or both and adding a well treatment composition to the fluid, wash or both. The composition comprises water, a lipophilic anionic surfactant, a hydrophilic non-ionic surfactant, a second non-ionic surfactant and a water-miscible solvent. Then the fluid, wash or both containing the composition are placed in the well such that the fluid, wash or both flow past the external surface of the casing string. An aqueous cement slurry is then prepared and placed in the well.

### BRIEF DESCRIPTION OF THE DRAWINGS

FIG. 1 is a plot illustrating how the conductivity of a NAF drilling fluid varies as it is contaminated by an aqueous spacer fluid.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

According to some embodiments of the current application, there is provided with compositions and methods for removing NAF drilling fluids from casing surfaces and leaving the surfaces water wet. In addition, the compositions may provide improved environmental suitability and compliance with local environmental regulations.

In an aspect, embodiments relate to well treatment compositions. The compositions comprise water, a lipophilic anionic surfactant, a hydrophilic non-ionic surfactant, a second non-ionic surfactant and a water-miscible solvent.

The surfactants are chosen according to their hydrophilic-lipophilic balances (HLB). The HLB is determined using either Griffin's method for non-ionic surfactants (scaling from 0 to 20) or Davies' method for anionic surfactants (scaling from 0 to 40). Additional information may be found in the following references. Griffin W C: “Calculation of HLB Values of Non-Ionic Surfactants,” Journal of the Society of Cosmetic Chemists 5 (1954): 249; and Davies J T: “A quantitative kinetic theory of emulsion type, I. Physical chemistry of the emulsifying agent,” Gas/Liquid and Liquid/Liquid Interface. Proceedings of the International Congress of Surface Activity (1957): 426-438. The entire content of the reference, Griffin W C: “Calculation of HLB Values of Non-Ionic Surfactants,” is hereby incorporated by reference into the current application. In the following description, Griffin HLB values are noted as HLBg and Davies HLB values are noted as HLBd.

The water concentration may be between 10 and 60 wt %, or between 10 and 50 wt %, or between 30 and 45 wt %. The lipophilic anionic surfactant concentration may be between 3 and 75 wt %, or between 5 and 40 wt %, or between 7 and 35 wt %. The hydrophilic non-ionic surfactant concentration may be between 3 and 75 wt %, or between 5 and 50 wt %, or between 10 and 30 wt %. The second non-ionic surfactant concentration may be between 3 and 75 wt %, or between 10 and 60 wt %, or between 20 and 50 wt %. The water-miscible solvent concentration may be between 3 and 75 wt %, or between 5 and 60 wt %, or between 8 and 30 wt %. The concentration ratio between the anionic surfactant and both non-ionic surfactants may be between 1:10 and 10:1 by weight, or between 1:4 and 4:1 by weight, or between 1:3 and 2:1 by weight.

The anionic surfactant may comprise oil-soluble alkaline, alkaline earth metal and amine dodecylbenzenesulfonates, alkylsulfates, alkylsulfonates, alpha olefin sulfonates, alkyl sulfosuccinates, alkyl ether sulfosuccinates, alkyl ether sulfates, alkyl ether sulfonates, carboxylates, lignosulfonates, phosphonate esters, phosphate esters, phosphonated polyglycol ethers, phosphated polyglycol ethers, or combinations thereof, wherein the HLBd value is lower than 30. The HLBd value may be lower than 25. The anionic surfactant may have one, two or three alkyl chains or branched alkyl chains or both. In some embodiments, the anionic surfactant comprises an alkyl sulfosuccinate.

The hydrophilic non-ionic surfactant may comprise alkoxylated alcohols, alkoxylated mercaptans, alkoxylated alkylphenols, alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids, flavolipids, or combinations thereof, wherein the HLBg value is between 12 and 17. The HLBg value may be between 13 and 16. In some embodiments, the hydrophilic non-ionic surfactant comprises an alkyl ethoxylate.

The second non-ionic surfactant may comprise alkoxylated alcohols, alkoxylated mercaptans, alkoxylated alkylphenols, alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids, flavolipids, or combinations thereof, wherein the HLBg value is between 7 and 14. The HLBg value may be between 8 and 13. In some embodiments, the second non-ionic surfactant may comprise propoxylated and ethoxylated alcohols.

Those skilled in the art will recognize that the hydrophilic non-ionic surfactant and the second non-ionic surfactant may be identical, provided their HLB numbers are within their prescribed ranges.

The water-miscible solvent may comprise linear or branched small chain alcohols according to the formula CₓH₍₂ₓ₊₁₎OH with x below 7, glycol ethers, dioxolanes, hydroxypyrrolidones, dimethylsulfoxide, dimethylformamide, acetic acid, acetone, amines, or combinations thereof. In some embodiments, the water-miscible solvent comprises glycol ether. In some embodiments, the water-miscible solvent comprises butoxyethanol.

For applications where the drilling fluid base oil is paraffinic or olefinic, the composition may further comprise a second solvent comprising branched long-chain alcohols according to the formula CₓH₍₂ₓ₊₁₎OH with x above 4, propoxylated alcohols, terpenes, pyrrolidones, pyrrolidines, aromatic solvents, halogenated solvents, or combinations thereof. In some embodiments, the second solvent comprises 2-ethyl-hexan-1-ol. The second solvent concentration may be between 5 and 50 wt %, or between 10 and 40 wt %.

In a further aspect, embodiments relate to methods for treating a subterranean well having at least one casing string. The method comprises preparing an aqueous spacer fluid, a chemical wash, or both, and adding a well treatment composition to the fluid, wash or both. The composition comprises water, a lipophilic anionic surfactant, a hydrophilic non-ionic surfactant, a second non-ionic surfactant and a water-miscible solvent. Then the fluid, wash or both containing the composition are placed in the well such that the fluid, wash or both flow past the external surface of the casing string. Details concerning the various compositional components and compositional ratios, including a second solvent, have been described previously. The concentration of the composition in the fluid, wash or both may be between 0.25 and 20 wt %, or between 2.5 and 10 wt %. In some embodiments, the fluid, wash or both, removes residuals of non-aqueous fluids (NAF) on the external surface of the casing string, wellbore surface, or both.

In yet a further aspect, embodiments relate to methods for cementing a subterranean well having at least one casing string, comprising preparing an aqueous spacer fluid, chemical wash or both and adding a well treatment composition to the fluid, wash or both. The composition comprises water, a lipophilic anionic surfactant, a hydrophilic non-ionic surfactant, a second non-ionic surfactant and a water-miscible solvent. Then the fluid, wash or both containing the composition are placed in the well such that the fluid, wash or both flow past the external surface of the casing string. An aqueous cement slurry is then prepared and placed in the well. The concentration of the composition in the fluid, wash or both may be between 0.25 and 20 wt %, or between 2.5 and 10 wt %. In some embodiments, the fluid, wash or both, removes residuals of non-aqueous fluids (NAF) on the external surface of the casing string, wellbore surface, or both.

The cement slurry may comprise Portland cement, calcium aluminum cement, fly ash, blast furnace slag, lime/silica blends, cement kiln dust, magnesium oxychloride, chemically bonded phosphate ceramics, zeolites, geopolymers, or combinations thereof. The cement slurry may further comprise additives comprising accelerators, retarders, extenders, weighting agents, fluid-loss additives, dispersants, gas generating agents, antifoam agents, nitrogen, microspheres, or combinations thereof.

Further illustration of the disclosure is provided by the following examples.

### EXAMPLES

As discussed earlier, effective NAF removal from casing and wellbore surfaces promotes cementing success. Four laboratory methods were used for evaluating the performance of the disclosed compositions, and the methods pertain to the present examples.

The first method was a rotor test to evaluate the ability of chemical-wash compositions to remove NAF from casing surfaces. Unless otherwise noted, the chemical wash solutions were prepared by diluting 10 vol % of the surfactant-solvent composition in water. The test equipment was a Chan 35™ rotational rheometer, available from Chandler Engineering, Tulsa, Okla., USA. The rheometer was equipped with two cups—one with an 85-mm diameter for tests conducted at 25° C. and 55° C., and one with a 50-mm diameter for tests conducted at 85° C. Two closed rotors, each 76.4 mm high and 40.6 mm in diameter, were employed to simulate the casing surface and provide an evaluation of test repeatability. Both rotors had a sand blasted stainless-steel surfaces with an average roughness of 2 μm.

A NAF was prepared and sheared at 6000 RPM in a Silverson mixer for 30 minutes, followed by a 16-hour aging period in a rolling oven at the desired test temperature. The NAF was then transferred to one of the Chan 35™ rheometer cups. A test rotor was weighted (w₀) and then lowered into the NAF to a depth of 50 mm. The rotor was then rotated within the NAF for one minute at 100 RPM and then left to soak in the NAF for five minutes. Next, the rotor was removed from the NAF and left to drain for two minutes. The bottom of the rotor was wiped clean and then weighed (w₁). The rotor was then remounted on the rheometer and immersed in a cup containing the chemical wash such that the NAF layer was just covered by the chemical wash. The rotor was rotated for 10 minutes at 100 RPM. The rotor was then removed from the chemical wash and left to drain for two minutes. The bottom of the rotor was wiped clean and weighed (w₂). The NAF removal efficiency R was then determined by Eq. 1.

$$R = \frac{{w}_{1} - {w}_{2}}{{w}_{1} - {w}_{0}} \qquad ( Eq . 1 )$$

The tests were repeated at least twice, and the results were averaged to obtain a final result. It is desirable to achieve an R value higher than 75%.

The second method involved spacer fluids containing the disclosed compositions, and determined the amount of spacer fluid necessary to destabilize a NAF emulsion, causing the external phase to become aqueous. The method used a Waring blender equipped with a glass bowl. The glass bowl was modified such that two electrodes were placed horizontally across the glass wall. The distance between the electrodes was 2.4 cm. The electrodes were connected to AC current through a potentiometer.

The method comprised:
1. The spacer fluid and NAF were conditioned separately in atmospheric consistometers at the desired test temperature for 30 minutes.
2. 400 mL of spacer fluid were poured into the glass bowl and mixed at 1000 RPM.
3. The electrical current between the electrodes immersed in the spacer fluid was adjusted to be 3 mA.
4. The glass bowl was emptied and cleaned.
5. 400 mL of NAF were poured into the glass bowl and mixed at 1000 RPM.
6. Spacer fluid was added incrementally to the NAF in the glass bowl. After each addition, a 14-mL sample was collected for measuring rheological properties with a Malvern Bohlin rheometer. As the spacer was added, the conductivity of the fluid was continuously measured. When the conductivity of the test fluid reached 1.5 mA, the NAF was considered to have converted from a resistive fluid to a conductive fluid.
   Under these conditions, in the absence of solvent or surfactant in the spacer fluid, the inversion regularly occurred at a spacer/NAF ratio of about 55/45. Achieving inversion at spacer/NAF ratios of 35/65 and below is desirable.

The third method was a rheological compatibility evaluation between the NAF and the spacer fluid. The viscosities of both fluids at a shear rate of 170 s⁻¹ were first determined. From these viscosities, a linear regression was performed to determine the “ideal” viscosity that would be observed for mixtures of various proportions (i.e., from 10/90 to 90/10). As described earlier, samples of spacer-fluid/NAF ratio mixtures were gathered during the NAF stability testing. The viscosity of each sample was determined and compared to the ideal viscosity at the corresponding spacer-fluid/NAF ratio. The difference between the ideal and measured viscosities (ideal minus measured) is called the “linear R-index.” The highest linear R-index that occurs across the spacer-fluid/NAF ratio spectrum is called the “absolute linear R-index.” The lower the absolute linear R-index, the more compatible the fluids are. Achieving an absolute linear R-index below +10 is desirable.

The fourth method was the measurement of the effect of the disclosed compositions on cement slurry thickening time. The base cement slurry density was 1890 kg/m³ (15.8 lbm/gal). The composition of the base cement slurry was Dyckerhoff Black Label Class G+83.5 g/L sodium polynaphthalene sulfonate+5.7 g/L polypropylene glycol+0.65 g/L welan gum+1 g/L sodium lignosulfonate. It is desirable that the thickening time of the mixture of the cement slurry and the disclosed surfactant-solvent composition be within ±20% of the thickening time of the base cement slurry.

600 mL of base slurry were prepared in a Waring blender, and 19 g of the surfactant-solvent composition were post-added to the slurry as it was agitated at 4000 RPM. This amount of surfactant-solvent blend corresponded to a 75/25 cement slurry/spacer ratio wherein 10 vol % of surfactant-solvent blend was present in the spacer.

Thickening-time tests were performed according to the recommended procedure published in the following document—Recommended Practice for Testing Well Cements, ANSI/API Recommended Practice JOB-2, 1st Edition, Washington DC: American Petroleum Institute (2005), the entire content of which is hereby incorporated by reference into the current application.

In the present examples, two non-aqueous (NAF) drilling fluids were used: VERSACLEAN™ and RHELIANT™, available from M-I SWACO, Houston, Tex., USA. The VERSACLEAN™ formulation used in the examples was based on mineral oil, with an 80/20 oil/water ratio. The RHELIANT™ formulation was based on synthetic oil (LAO 16/18 from Ineos Oligomers), with a 75/25 oil/water ratio. Both drilling fluids were weighted with barite to a density of 1500 kg/m³ (12.5 lbm/gal). The spacer fluid that was tested in the present examples was MUDPUSH™ II spacer fluid, available from Schlumberger. Advantageously, a given surfactant-solvent blend will demonstrate desirable cleaning results with both types of NAF drilling fluids—those based on mineral oil and those based on synthetic oil.

### Example 1

The following surfactant-solvent blend was prepared in a beaker with a magnetic stirrer, and agitated until the solution was homogeneous.
5 wt % sodium dioctylsulfosuccinate in glycol-water solution (Geropon™ DOS PG, available from Rhodia).
6 wt % tridecyl alcohol ethoxylate (Rhodasurf™ BC-840, available from Rhodia)
12 wt % branched alcohol EO/PO (Antarox™ LA-EP 16, available from Rhodia)
21 wt % water
56 wt % butoxyethanol

Geropon™ DOS PG is an anionic surfactant with an HLBd of 23. Rhodasurf™ BC-840 is a non-ionic surfactant with an HLBg of 15.4. Antarox™ LA-EP 16 is a non-ionic surfactant with an HLBg of 13.1

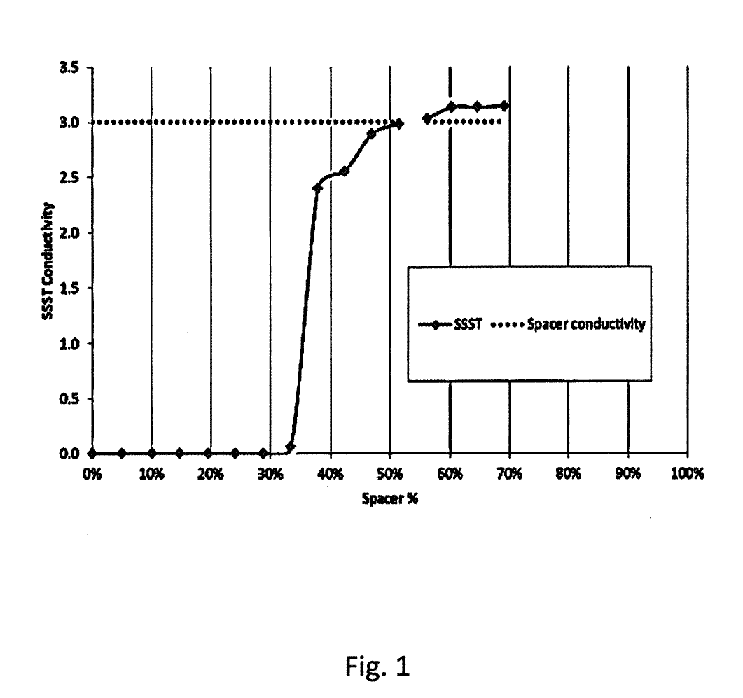

Rotor tests conducted with the drilling fluids had the following results. VERSACLEAN™: R=85%; RHELIANT™: R=80%. A stability test was performed with the RHELIANT™ fluid. The emulsion inverted when the spacer/drilling-fluid ratio was 35/65 (FIG. 1).

### Example 2

The following surfactant-solvent blend was prepared in a beaker with a magnetic stirrer, and agitated until the solution was homogeneous.
7 wt % Geropon™ DOS PG
4 wt % Rhodasurf™ BC-840
25 wt % alcohol ethoxylate propoxylate (HLBg=12.3)
12 wt % water
52 wt % butoxyethanol

Rotor tests conducted with the drilling fluids had the following results. VERSACLEAN™: R=100%; RHELIANT™: R=75%. A stability test was performed with the RHELIANT™ fluid. The emulsion inverted when the spacer/drilling-fluid ratio was 29/71. Another stability test was performed with the VERSACLEAN™ fluid. The emulsion inverted when the spacer/drilling-fluid ratio was 33/67.

Rheological compatibility tests were performed. The absolute R-indices associated with the VERSACLEAN™ and RHELIANT™ drilling fluids were 10 and 13, respectively.

The influence of the surfactant-solvent blend on the cement thickening time is shown in Table 1.

TABLE 1
Effect of surfactant-solvent combination on cement slurry thickening time.

| | Thickening Time @ 66° C. (150° F.) | |
|---|---|---|
| | 30 Bc (hr:min) | 100 Bc (hr:min) |
| No surfactant-solvent | 6:10 | 6:40 |
| 19 g/600 mL surfactant-solvent | 5:05 | 5:35 |

### Example 3

The following surfactant-solvent blend was prepared in a beaker with a magnetic stirrer, and agitated until the solution was homogeneous. This blend does not contain all of the ingredients specified by the Applicants.
50 wt % Antarox™ LA-EP 16
50 wt % butoxyethanol

Rotor tests conducted with the drilling fluids had the following results. VERSACLEAN™: R=40%; RHELIANT™: R=80%. A stability test was performed with the RHELIANT™ fluid. The emulsion inverted when the spacer/drilling-fluid ratio was 10/90. Another stability test was performed with the VERSACLEAN™ fluid. The emulsion inverted when the spacer/drilling-fluid ratio was 25/75.

Rheological compatibility tests were performed. The absolute R-indices associated with the VERSACLEAN™ and RHELIANT™ drilling fluids were +11 and −12, respectively.

The influence of the surfactant-solvent blend on the cement thickening time is shown in Table 2.

TABLE 2
Effect of surfactant-solvent combination on cement slurry thickening time.

| | Thickening Time @ 55° C. (131° F.) | |
|---|---|---|
| | 30 Bc (hr:min) | 100 Bc (hr:min) |
| No surfactant-solvent | 3:15 | 3:52 |
| 19 g/600 mL surfactant-solvent | 3:19 | 3:44 |

### Example 4

The following surfactant-solvent blend was prepared in a beaker with a magnetic stirrer, and agitated until the solution was homogeneous. This blend does not contain the second nonionic surfactant specified by the Applicants (The HLBg number for Rhodasurf™ BC-840 is higher than 14)
15 wt % Geropon™ DOS PG
8 wt % Rhodasurf™ BC-840
24 wt % water
53% butoxyethanol

Rotor tests conducted with the drilling fluids had the following results. VERSACLEAN™: R=95%; RHELIANT™: R=70%. A stability test was performed with the RHELIANT™ fluid. The emulsion inverted when the spacer/drilling-fluid ratio was 50/50. Another stability test was performed with the VERSACLEAN™ fluid. The emulsion inverted when the spacer/drilling-fluid ratio was 35/65.

Rheological compatibility tests were performed. The absolute R-indices associated with the VERSACLEAN™ and RHELIANT™ drilling fluids were +29 and 11, respectively.

The influence of the surfactant-solvent blend on the cement thickening time is shown in Table 3.

TABLE 3
Effect of surfactant-solvent combination on cement slurry thickening time.

| | Thickening Time @ 55° C. (131° F.) | |
|---|---|---|
| | 30 Bc (hr:min) | 100 Bc (hr:min) |
| No surfactant-solvent | 3:15 | 3:52 |
| 19 g/600 mL surfactant-solvent | 2:34 | 3:35 |

### Example 5

The following surfactant-solvent blend was prepared in a beaker with a magnetic stirrer, and agitated until the solution was homogeneous. The HLBd value for the anionic surfactant exceeds the range specified by the Applicants.
12.5 wt % sodium alkylethersulfate in water (Sulframin™ B320, available from Akzo Nobel—HLB=43)
12.5 wt % laureth-4 carboxylate, available from Sigma Aldrich (HLB=25)
6 wt % tridecyl alcohol ethoxylate, available from Sigma Aldrich (HLB=14)
13 wt % water
6 wt % propan-2-ol
50 wt % d-limonene

Rotor tests conducted with the drilling fluids had the following results. VERSACLEAN™: R=45%; RHELIANT™: R=92%.

The influence of the surfactant-solvent blend on the cement thickening time is shown in Table 4.

TABLE 4
Effect of surfactant-solvent combination on cement slurry thickening time.

| | Thickening Time @ 55° C. (131° F.) | |
|---|---|---|
| | 30 Bc (hr:min) | 100 Bc (hr:min) |
| No surfactant-solvent | 3:15 | 3:52 |
| 19 g/600 mL surfactant-solvent | 11:21 | 12:03 |

### Example 6

A chemical wash solution was prepared by diluting 5 vol % of the following composition in water. This blend does not contain all of the ingredients specified by the Applicants.
100 wt % Rhodasurf™ BC-840

Rotor tests conducted with the drilling fluids had the following results. VERSACLEAN™: R=5%; RHELIANT™: R=5%.

### Example 7

A chemical wash solution was prepared by diluting 5 vol % of the following composition in water. This blend does not contain all of the ingredients specified by the Applicants.
100 wt % Antarox™ LA-EP 16

Rotor tests conducted with the drilling fluids had the following results. VERSACLEAN™: R=30%; RHELIANT™: R=30%.

### Example 8

A chemical wash solution was prepared by diluting 5 vol % of the following composition in water. This blend does not contain all of the ingredients specified by the Applicants.
100 wt % butoxyethanol

Rotor tests conducted with the drilling fluids had the following results. VERSACLEAN™: R=40%; RHELIANT™: R=35%.

### Example 9

A chemical wash solution was prepared by diluting 5 vol % of the following composition in water. This blend does not contain all of the ingredients specified by the Applicants.
100 wt % Geropon™ DOS PG

Rotor tests conducted with the drilling fluids had the following results. VERSACLEAN™: R=10%; RHELIANT™: R=11%.

### Example 10

The following surfactant-solvent blend was prepared in a beaker with a magnetic stirrer and agitated until the solution was homogeneous. The water-miscible solvent concentration in this blend is below the range specified by the Applicants, and the water concentration is higher than the specified range.
8 wt % Geropon™ DOS PG
22 wt % Antarox™ LA-EP 16
68 wt % water
2 wt % butoxyethanol

A chemical wash solution was prepared by diluting 5 vol % of the surfactant-solvent preparation in water.

A rotor test with a drilling fluid had the following result. VERSACLEAN™: R=57%.

### Example 11

The following surfactant-solvent blend was prepared in a beaker with a magnetic stirrer and agitated until the solution was homogeneous. This example demonstrates an instance when the first and second nonionic surfactants are the same. The HLBg value of the Antarox™ surfactant (13.1) lies within the ranges specified by the Applicants for the first and second nonionic surfactants.
8 wt % Geropon™ DOS PG
22 wt % Antarox™ LA-EP 16
34 wt % water
51 wt % butoxyethanol

A chemical wash solution was prepared by diluting 5 vol % of the surfactant-solvent preparation in water.

A rotor test with a drilling fluid had the following result. VERSACLEAN™: R=85%.

In summary, the examples demonstrate that solvent-surfactant blends that conform to the compositional ranges specified by the Applicants provide satisfactory results with both mineral-oil and synthetic-oil base drilling fluids—a high linear R-index, good rheological compatibility between drilling fluid and spacer fluid, early emulsion inversion in drilling fluid/spacer fluid mixtures, and no significant impact on cement slurry thickening time. Solvent-surfactant blends that are not in conformance with the compositional ranges specified by the Applicants may provide satisfactory results with one type of drilling fluid, but not with the other.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A well treatment composition, comprising:
i. water;
ii. a lipophilic anionic surfactant;
iii. a hydrophilic non-ionic surfactant;
iv. a second non-ionic surfactant; and
v. a water-miscible solvent.

2. The composition of claim 1, wherein the anionic surfactant comprises oil-soluble alkaline, alkaline earth metal and amine dodecylbenzenesulfonates, alkylsulfates, alkylsulfonates, alpha olefin sulfonates, alkyl sulfosuccinates, alkyl ether sulfosuccinates, alkyl ether sulfates, alkyl ether sulfonates, carboxylates, phosphonate esters, phosphate esters, phosphonated polyglycol ethers, phosphated polyglycol ethers, or combinations thereof, wherein the HLBd value is lower than 30.

3. The composition of claim 1, wherein the hydrophilic non-ionic surfactant comprises alkoxylated alcohols, alkoxylated mercaptans, alkoxylated alkylphenols, alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids, flavolipids, or combinations thereof, wherein the HLBg value is between 12 and 17.

4. The composition of claim 1, wherein the second non-ionic surfactant comprises alkoxylated alcohols, alkoxylated mercaptans, alkoxylated alkylphenols alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids, flavolipids, or combinations thereof, wherein the HLBg value is between 7 and 14.

5. The composition of claim 1, wherein
the water-miscible solvent comprises linear or branched small chain alcohols according to the formula CₓH₍₂ₓ₊₁₎OH with x below 7, glycol ethers, dioxolanes, hydroxypyrrolidones, dimethylsulfoxide, dimethylformamide, acetic acid, acetone, amines, or combinations thereof.

6. The composition of claim 1, further comprising a second solvent comprising branched long-chain alcohols according to the formula CₓH_{(2x 1)}OH with x above 4, propoxylated alcohols, terpenes, pyrrolidones, pyrrolidines, aromatic solvents, halogenated solvents, or combinations thereof.

7. The composition of claim 1, wherein the concentration ratio between the anionic surfactant and both non-ionic surfactants is between 1:10 and 10:1 by weight.

8. The composition of claim 1, wherein the water in the composition is between 10 and 60 wt %.

9. The composition of claim 1, wherein the lipophilic anionic surfactant in the composition is between 3 and 75 wt %.

10. The composition of claim 1, wherein the hydrophilic non-ionic surfactant in the composition is between 3 and 75 wt %.

11. The composition of claim 1, wherein the second non-ionic surfactant in the composition is between 3 and 75 wt %.

12. The composition of claim 1, wherein the water-miscible solvent in the composition is between 3 and 75 wt % and the concentration ratio between the anionic surfactant and both non-ionic surfactants may be between 1:10 and 10:1 by weight.

13. A method for treating a subterranean well having at least one casing string, comprising:
i. preparing an aqueous spacer fluid, chemical wash or both comprising the well treatment composition comprised of:
water;
a lipophilic anionic surfactant;
a hydrophilic non-ionic surfactant;
a second non-ionic surfactant; and
a water-miscible solvent; and
ii. placing the fluid, wash or both in the well such that the fluid, wash or both flow past the external surface of the casing string.

14. The method of claim 13, wherein the concentration of the composition in the fluid, wash or both is between 0.25% and 20% by weight.

15. The method of claim 13, further comprising:
iii. placing an aqueous cement slurry in the well.
